(19) United States
(12) Patent Application Publication
(10) Pub. No.: US 2025/0181115 A1
(43) Pub. Date: Jun. 5, 2025

(54) ELECTRONIC DEVICE

(71) Applicant: Lenovo (Beijing) Limited, Beijing (CN)

(72) Inventor: Sai GAO, Beijing (CN)

(21) Appl. No.: 18/963,101

(22) Filed: Nov. 27, 2024

(30) Foreign Application Priority Data
Nov. 30, 2023 (CN) 202311631427.7

(51) Int. Cl. G06F 1/16

(52) U.S. Cl. CPC G06F 1/1641; G06F 1/1616; G06F 1/1656; G06F 1/1675

(57) ABSTRACT

An electronic device includes a first body, a second body, a third body, and a display assembly. The first body includes an input assembly. An input surface of the input assembly is used as a first functional surface of the first body. A first side of the second body is rotatably connected to the first body. The third body is rotatably connected to a second side of the second body. A display assembly includes a first surface and a second surface arranged opposite the first surface. The first surface is a display output surface of the display assembly. The second surface is connected to the second body and the third body. The display output surface does not overlap with the input surface. In response to the third body rotating relative to the second body to form a first device form, then the display assembly is in a first deformed state.

### CROSS-REFERENCE TO RELATED APPLICATION

This application claims priority to Chinese Patent Application No. 202311631427.7, filed on Nov. 30, 2023, and the entire content of which is incorporated herein by reference.

### TECHNICAL FIELD

The present disclosure relates to the field of electronic device technology and, more particularly, to an electronic device.

### BACKGROUND

When using an electronic device, the form of the electronic device can be adjusted according to different user habits or the needs of the usage scenario. In the process of adjusting the form of the electronic device, different parts of the electronic device may undergo relative movement to switch the device between different configurations. A sequence in which the different parts of the electronic device move relative to each other determines which form the device will switch first. However, the user may not know which part of the device to adjust first, or when intending to adjust the first part, the second part may be moved instead. This makes the process of switching the form of the electronic device too complicated for the user.

### SUMMARY

An electronic device includes a first body, a second body, a third body, and a display assembly. The first body includes an input assembly. An input surface of the input assembly is used as a first functional surface of the first body. A first side of the second body is rotatably connected to the first body. The third body is rotatably connected to a second side of the second body. A display assembly includes a first surface and a second surface arranged opposite the first surface. The first surface is a display output surface of the display assembly. The second surface is connected to the second body and the third body. The display output surface does not overlap with the input surface. In response to the third body rotating relative to the second body to form a first device form, then the display assembly is in a first deformed state, and in the first deformed state, the input surface and the display output surface of the display assembly are on a same side relative to the electronic device. In response to the third body rotating relative to the second body and the second body rotating relative to the first body, to form a second device form, the display assembly is in a flat state, and the input surface and the display output surface of the display assembly that is in the flat state are on a same side relative to the electronic device.

### BRIEF DESCRIPTION OF THE DRAWINGS

To more clearly illustrate the technical solutions in the embodiments of the present disclosure, drawings required for the description of the embodiments are briefly described below. Obviously, the drawings described below are merely some embodiments of the present disclosure. For those skilled in the art, other drawings can be obtained based on these drawings without creative efforts.

FIG. 1 is a diagram of the electronic device provided by the present disclosure in a closed form;

FIG. 2 is a first diagram of the electronic device provided by the present disclosure in a first device form;

FIG. 3 is a first diagram of the electronic device provided by the present disclosure in a second device form;

FIG. 4 is a second diagram of the electronic device provided by the present disclosure in the first device form;

FIG. 5 is a second diagram of the electronic device provided by the present disclosure in the second device form;

FIG. 6 is a diagram of the electronic device provided by the present disclosure in a transitional configuration;

FIG. 7 is a diagram of the structure of the first connection apparatus in the electronic device provided by the present disclosure;

FIG. 8 is an exploded view of the second connection apparatus in the electronic device provided by the present disclosure;

FIG. 9 is a diagram of the structure of the second connection apparatus in the electronic device provided by the present disclosure.

### REFERENCE NUMERALS

1—First body; 11—Input assembly; 12—Second functional surface; 2—Second body; 21—First side; 22—Second side; 3—Third body; 4—Display assembly; 41—First surface; 5—First connection apparatus; 51—First rotation shaft; 52—First connection member; 53—Second connection member; 6—Second connection apparatus; 61—Third connection member; 62—Fourth connection member; 63—Intermediate connection member; 64—Transmission assembly; 641—Sliding member; 642—First rotating member; 643—Second rotating member; 65—Second rotation shaft; 66—Elastic member; 67—Fastening member; 68—Synchronizing member; 7—Support assembly; A—First angle; B—Second angle; C—Thickness direction; D—Axial direction

### DETAILED DESCRIPTION OF THE EMBODIMENTS

To enable those skilled in the art to better understand the technical solutions of the embodiments of the present disclosure, the technical solutions in the embodiments of the present disclosure will be clearly and completely described below in conjunction with the accompanying drawings. Obviously, the described embodiments are merely part of the embodiments of the present disclosure, not all of the embodiments. Based on the embodiments of the present disclosure, all other embodiments obtained by those skilled in the art without creative work are within the scope of the present disclosure.

In the embodiments of the present disclosure, the terms “first” and “second” are used solely for descriptive purposes and should not be understood as indicating or implying relative importance or implicitly specifying the number of technical features indicated. Therefore, features defined as “first” or “second” may explicitly or implicitly include one or more of such features. In the description of the embodiments of the present application, unless otherwise specified, “multiple” means two or more.

Furthermore, in the embodiments of the present disclosure, terms like “upper”, “lower”, “left”, and “right” are defined based on the relative positions of the components shown in the accompanying drawings. It should be understood that these directional terms are relative concepts used for descriptive and clarifying purposes and may change accordingly depending on the orientation of the components in the drawings.

In the embodiments of the present disclosure, unless explicitly specified otherwise, the term “connection” should be interpreted broadly. For example, “connection” can refer to a fixed connection, a detachable connection, or an integrated connection; it can refer to a direct connection or an indirect connection through an intermediary.

In the embodiments of the present disclosure, the terms “include”, “comprise”, or any of their variations are intended to cover non-exclusive inclusion. Thus, a process, method, article, or apparatus that includes a series of elements not only includes those elements but may also include other elements not explicitly listed, or may include elements inherent to such a process, method, article, or apparatus. Unless specified otherwise, an element defined by the phrase “includes a . . . ” does not exclude the presence of additional elements of the same type in the process, method, article, or apparatus that includes the element.

In the embodiments of the present disclosure, the words “exemplary” or “for example” are used to illustrate examples or for explanatory purposes. Any embodiment or design described as “exemplary” or “for example” should not be construed as being preferred or superior to other embodiments or designs. Rather, the use of “exemplary” or “for example” is intended to present concepts in a specific manner.

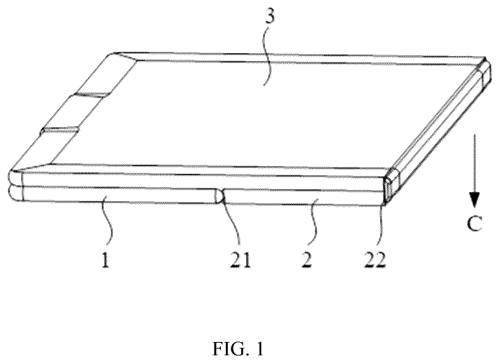

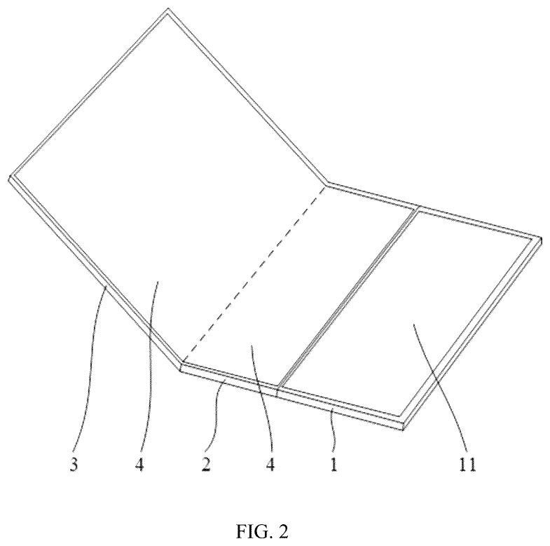

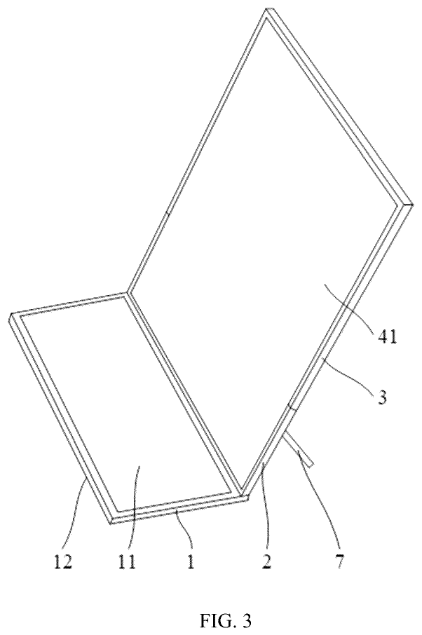

As shown in FIG. 1, FIG. 2, and FIG. 3, FIG. 1 is a diagram of the electronic device provided by the present disclosure in a closed form; FIG. 2 is a first diagram of the electronic device provided by the present disclosure in a first device form; and FIG. 3 is a first diagram of the electronic device provided by the present disclosure in a second device form. The electronic device includes: a first body 1, a second body 2, a third body 3, and a display assembly 4. The first body 1 comprises an input assembly 11, and the input surface of the input assembly 11 serves as a first functional surface of the first body 1. A first side 21 of the second body 2 is rotatably connected to the first body 1. The third body 3 is rotatably connected to a second side 22 of the second body 2. The display assembly 4 has a first surface 41 and a second surface opposite to the first surface 41, where the first surface 41 is the display output surface of the display assembly 4, and the second surface is connected to the second body 2 and the third body 3. The display output surface of the display assembly 4 does not overlap with the input surface. In this case, if the third body 3 rotates relative to the second body 2 to form a first device form, the display assembly 4 is in a first deformed state. In the first deformed state, the input surface and the display output surface of the display assembly 4 are on the same side of the electronic device. If the third body 3 rotates relative to the second body 2 and the second body 2 rotates relative to the first body 1 to form a second device form, the display assembly 4 is in a flat state, and the input surface and the display output surface of the display assembly 4 in the flat state are on the same side of the electronic device.

In the embodiments of the present disclosure, the first body 1 can be the part of the electronic device where the user inputs information and/or where the electronic device outputs information during human-computer interaction. An input assembly 11 can be configured on the first body 1. The input assembly 11 includes an input surface. The input surface can cover partial area of the input assembly 11, or the entire area of the input assembly 11. The input surface serves as the first functional surface on the first body 1, allowing the user to input information into the electronic device through the input surface, to enable interaction with the electronic device. For example, the input assembly 11 may be a keyboard, touchpad, joystick, etc.

In some embodiments of the present disclosure, the second body 2 has at least two sides, and the second body 2 can be connected to the first body 1. For example, the first side 21 of the second body 2 is rotatably connected to one side of the first body 1, allowing the second body 2 to rotate relative to the first body 1. This enables adjustment of the form between the second body 2 and the first body 1.

In some embodiments of the present disclosure, the third body 3 can be connected to the second side 22 of the second body 2. For example, the third body 3 is rotatably connected to the second side 22 of the second body 2, allowing the third body 3 to rotate relative to the second body 2. This enables adjustment of the form between the third body 3 and the second body 2.

In some embodiments of the present disclosure, the display assembly 4 can be the output component and/or the input assembly 11 of the electronic device, providing a human-computer interaction interface. For example, the display assembly 4 has a first surface 41 and a second surface arranged opposite to each other. The first surface 41, serves as the display output surface of the display assembly 4, displaying interactive information such as images and text to the user. The second surface is used to connect with both the second body 2 and the third body 3, letting the display assembly 4 connecting to both the second body 2 and the third body 3. In other words, the first surface 41 of the display assembly 4 covers both the second body 2 and the third body 3. When installing the display assembly 4, the display output surface is adjacent to or has a gap with the input surface on the first body 1. The input surface and the output surface of the display does not overlap each other. For example, the display assembly 4 can be a display screen or a touch screen.

In some embodiments of the present disclosure, both the first body 1 and the third body 3 are rotatably connected to the second body 2. By rotating the second body 2 and/or the third body 3, the position of the second body 2 and/or the third body 3 relative to the first body 1 can be adjusted, which alters the form of the electronic device.

In an exemplary embodiment, as shown in FIG. 1, when the electronic device is not in use, the second body 2 can be rotated so that the second body 2 and the first body 1 are in the same plane. By rotating the third body 3 so that the third body 3 is adjacent to both the second body 2 and the first body 1, the electronic device can be placed in a closed form.

In another exemplary embodiment, as shown in FIG. 2, by adjusting the position of the third body 3 relative to the second body 2, the electronic device can form a first device form. Specifically, the third body 3 rotates relative to the second body 2 in a direction away from the first body 1, with the third body 3 positioned away from the first body 1. In this case, the part of the display assembly 4 connected to the third body 3 rotates along with the third body 3 to a position away from the first body 1, placing the display assembly 4 in a first deformed state. In this state, the display output surface of the display assembly 4 is bent into two sections with an angle between them, and these two sections are connected as a single unit to collectively display output content. Additionally, the input surface on the first body 1 and the adjacent section of the display output surface are in the same plane, with all parts of the input surface and display output surface located on the same side of the electronic device.

In another exemplary embodiment, as shown in FIG. 3, the electronic device can form a second device form by adjusting the position of the third body 3 relative to the second body 2, as well as adjusting the position of the second body 2 relative to the first body 1. Specifically, the third body 3 rotates relative to the second body 2 in a direction away from the first body 1, with the third body 3 positioned away from the first body 1, and the second body 2 rotates relative to the first body 1 in a direction closer to the display assembly 4 by a certain angle. In this case, the third body 3 and the second body 2 are in a same plane, and the second body 2 and the first body 1 are connected at an angle. The part of the display assembly 4 connected to the third body 3 rotates along with the third body 3 to a position away from the first body 1, placing the display assembly 4 in a flat state. In this state, all parts of the display output surface of the display assembly 4 are in the same plane. Additionally, there is an angle between the input surface on the first body 1 and the entire display output surface, while both the input surface and the entire display output surface are located on the same side of the electronic device.

The electronic device provided in the present disclosure, includes the first body 1, equipped with an input assembly, wherein an input surface of the input assembly 11 serves as a first functional surface. Information can be input through the input surface. Moreover, a first side 21 of the second body 2 is rotatably connected to the first body 1, and a second side 22 of the second body 2 is rotatably connected to the third body 3. The display assembly 4 is on the same side of both the second body 2 and the third body 3. Not only can the display assembly 4 display interactive information, but as the third body 3 rotates relative to the second body 2, or after the third body 3 rotates relative to the second body 2 and the second body 2 rotates relative to the first body 1, the display output surface can adopt different forms, enabling the electronic device to have multiple device forms. Additionally, by configuring the torque of the connection mechanism that rotatably connects the second body 2 to the first body 1, and the connection mechanism that rotatably connects the third body 3 to the second body 2, the second body 2 can remain stationary relative to the first body 1, while the third body 3 rotates relative to the second body 2. This makes the electronic device easier to be adjusted to the first device form, and also continent the switching between the first device form, the second device form, and the closed form, which simplifies the steps for switching the electronic device between multiple forms.

In some embodiments of the present disclosure, as shown in FIG. 3, the first body 1 can be configured to have a second functional surface 12. The second functional surface 12 is used to abut against a supporting surface and support the third body 3, which is connected to the second body 2.

In some embodiments of the present disclosure, to facilitate supporting the electronic device, a second functional surface 12 can be provided on the first body 1 to support the electronic device through the second functional surface 12.

In an exemplary embodiment, as shown in FIG. 3, the side of the first body 1 which is opposite to the input assembly 11, can be used as the second functional surface 12. Supporting elements, such as foot pads, supporting elements such as foot pads, which provide supporting force, can be configured on the second functional surface 12, which enhances the stability of the second functional surface 12 in supporting the electronic device. In this case, when the electronic device is in the first device form or the second device form, the second functional surface 12 of the first body 1 can abut against the supporting surface on which the electronic device is placed. This supports the second body 2 and third body 3 of the electronic device, which allows the third body 3 and second body 2 to form an angle, or the second body 2 and first body 1 to form an angle.

In the above embodiment, since the first body 1 is provided with the second functional surface 12, the second functional surface 12 can be used as a part that provides supporting force to the electronic device, supporting the second body 2 and the third body 3 through the second functional surface 12.

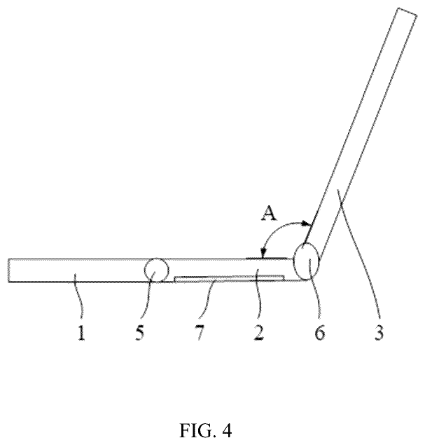

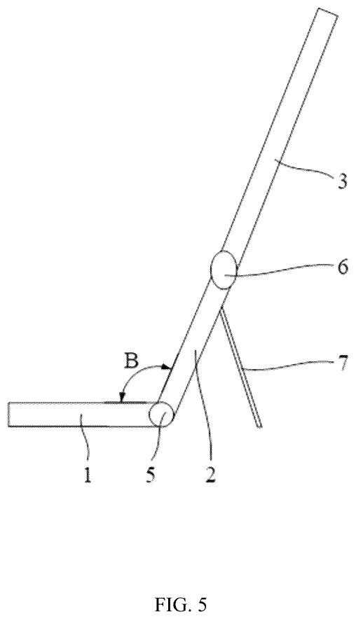

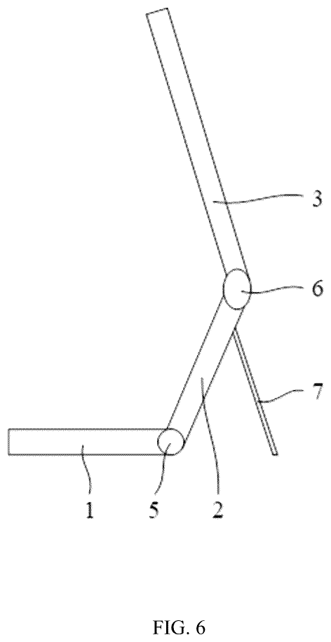

In some embodiments of the present disclosure, referring to FIG. 4, FIG. 5, and FIG. 6, FIG. 4 shows a second diagram of the first device form of the electronic device provided by the present disclosure, FIG. 5 shows a second diagram of the second device form of the electronic device provided by the present disclosure, and FIG. 6 shows a diagram of the transitional form of the electronic device provided by the present disclosure. As shown in FIG. 2 and FIG. 4, when the electronic device is in the first device form, the first body 1 and the second body 2 satisfy a coplanar condition, and the second body 2 and the third body 3 form a first angle A. As shown in FIG. 3, FIG. 5, and FIG. 6, when the electronic device is in the second device form, the second body 2 and the third body 3 form the first angle A or satisfy the coplanar condition, and the second body 2 and the first body 1 form a second angle B.

In some embodiments of the present disclosure, the first body 1 and the third body 3 of the electronic device are both rotatably connected to the second body 2. When switching the electronic device from the closed form shown in FIG. 1 to the first device form shown in FIG. 4, the third body 3 can be rotated in a direction away from the first body 1 relative to the second body 2, while the second body 2 remains stationary relative to the first body 1 during this process. This allows the second body 2 and the first body 1 to maintain the coplanar condition, which means that the planes of the second body 2 and the first body 1 are parallel or nearly parallel, while the third body 3 and the second body 2 form a first angle A. The first angle A can be any angle between 0° and 180°, but it is typically between 90° and 150°. At this time, the parts of the display assembly 4 connected to the second body 2 and the third body 3 form two sections with an angle between them, which equals to the angle between the second body 2 and the third body 3.

In some embodiments of the present disclosure, when switching the electronic device from the closed form or the first device form to the second device form, the third body 3 can first be rotated relative to the second body 2 in a direction away from the first body 1, placing the electronic device in the first device form. Then, the second body 2 can be rotated relative to the first body 1 in a direction closer to the display assembly 4, switching the second body 2 and the first body 1 from a coplanar state to a state where they form a second angle B. The second angle B can be any angle between 90° and 180°, and in the coplanar state, the angle between the second body 2 and the first body 1 can be 180°. At this time, the electronic device is in a transitional form, as shown in FIG. 6, with the first angle A between the third body 3 and the second body 2 being another angle, and the parts of the display assembly 4 connected to the second body 2 and the third body 3 also forming a first angle with another value. The third body 3 can then be further rotated in a direction away from the first body 1, bringing the third body 3 and the second body 2 into a coplanar state, thus switching the electronic device to the second device form, as shown in FIG. 5. At this time, the parts of the display assembly 4 connected to the second body 2 and the third body 3 are also in a coplanar state.

In the above embodiment, by rotating the third body 3 and/or the second body 2 of the electronic device, the electronic device can be switched from the closed form to the first device form or the second device form, allowing the electronic device to adopt various forms. This enables the device to meet user requirements in different application scenarios.

In some embodiments of the present disclosure, as shown in FIG. 1, the electronic device has a closed form. In the closed form, the first body 1 and the second body 2 satisfy the coplanar condition, and an orthogonal projection of the third body 3 in the thickness direction C at least partially covers the first body 1 and the second body 2. The first functional surface is on the same side as the display output surface of the display assembly 4 and satisfies the coplanar condition with at least part of the display output surface.

In some embodiments of the present disclosure, by rotating the second body 2 and the third body 3, the electronic device can be switched to the closed form, where the input assembly 11 and the display assembly 4 are in a stowed and hidden state. In this case, the first body 1 and the second body 2 are in the coplanar state, and the third body 3 is adjacent to or in contact with both the second body 2 and the first body 1. In this case, along the thickness direction C of the third body 3, a full projection or a partial projection of the third body 3 can cover the first body 1 and the second body 2. The display output surface of the display assembly 4 is also folded, and the two parts of the display output surface positioned opposite each other. The first functional surface is coplanar with the part of the display output surface located on the second body 2, and both the first functional surface and the part of the display output surface on the second body 2, are both located on the same side as the part of the display output surface on the third body 3.

In some embodiments of the present disclosure, the electronic device can be switched from the closed state to the flattened state by rotating the third body 3, by rotating the third body 3 relative to the second body 2 in a direction away from the first body 1 by nearly 180°. In this case, the first body 1, the second body 2, and the third body 3 are all in the coplanar state, which means that the first body 1, the second body 2, and the third body 3 are all positioned in the same plane, or the planes of the first body 1, the second body 2, and the third body 3 are parallel or nearly parallel to each other. At this point, the display output surface of the display assembly 4 is in a flat stare as an entirety, and the input surface of the input assembly 11 is positioned on one side of the display output surface.

In the above embodiment, by rotating the second body 2 and the third body 3, the electronic device can be configured in the closed form, which facilitates the storage and safekeeping of the device. The first body 1, second body 2, and third body 3 can cover the input assembly 11 and the display assembly 4, providing protection for the input assembly 11 and the display assembly 4, which reduces the likelihood of accidental operation of the electronic device.

In some embodiments of the present disclosure, as shown in FIG. 1, FIG. 4, FIG. 5, and FIG. 6, a first side 21 and a second side 22 of the second body 2 are two opposing sides of the second body 2. The first side 21 of the second body 2 is connected to the first body 1 via a first connection apparatus 5, which is used to form and maintain the first device form. The second side 22 of the second body 2 is connected to the third body 3 via a second connection apparatus 6, which is used to form and maintain the second device form.

In the embodiments of the present disclosure, the first side 21 and the second side 22 of the second body 2 can be opposing sides of the second body 2, which facilitates the rotational connection between the first body 1 and the third body 3 with the second body 2.

In an exemplary embodiment, the first side 21 of the second body 2 can be connected to one side of the first body 1 using a first connection apparatus 5. The structural components included in the first connection apparatus 5, are connected to the first body 1 and the second body 2 respectively, allowing relative rotation, which enables the first body 1 and the second body 2 to rotate relative to each other. This allows the first body 1 and the second body 2 to be in a coplanar state. The force provided by the first connection apparatus 5 maintains the first body 1 and the second body 2 in this coplanar state.

In another exemplary embodiment, the second side 22 of the second body 2 can be connected to one side of the third body 3 using a second connection apparatus 6. The structural components included in the second connection apparatus 6, are connected to the second body 2 and the third body 3 respectively, allowing relative rotation, which enables the second body 2 and the third body 3 to rotate relative to each other. This allows the third body 3 and the second body 2 to be in a coplanar state or in a state forming a first angle A. The force provided by the second connection apparatus 6 maintains the third body 3 and the second body 2 in a coplanar state or in a state with the first angle A.

In the above embodiment, by providing a first connection apparatus 5 between the first side 21 of the first body 1 and the second body 2, the first connection apparatus 5 enables relative rotation between the first body 1 and the second body 2, and maintains them in the rotated position. By providing a second connection apparatus 6 between the second side 22 of the second body 2 and the third body 3, the second connection apparatus 6 enables relative rotation between the third body 3 and the second body 2, and maintains them in the rotated position. As a consequence, through the first connection apparatus 5 and the second connection apparatus 6, the electronic device can form and maintain the first device form or the second device form.

In some embodiments of the present disclosure, the first connection apparatus 5 provides a first force during the rotation of the second body 2 relative to the first body 1. The second connection apparatus 6 provides a second force during the rotation of the third body 3 relative to the second body 2. The first force is greater than the second force, which allows the first device form to transition to the second device form.

In some embodiments of the present disclosure, the torque of the first connection apparatus 5 and the second connection apparatus 6 can be adjusted, so that the magnitude and direction of the first force provided by the first connection apparatus 5 to the first body 1 and the second body 2 are different from the second force provided by the second connection apparatus 6 to the third body 3 and the second body 2.

In an exemplary embodiment, the torque of the second connection apparatus 6 during rotation can be set to be smaller than the torque of the first connection apparatus 5 during rotation. In this case, when an external force is applied to the third body 3, making it to rotate toward the first body 1, the second body 2 will not rotate relative to the first body 1.

In another exemplary embodiment, the rotational angles of the first connection apparatus 5 and the second connection apparatus 6 can be set to different angles. For instance, the rotational angle of the first connection apparatus 5 can be set between 0° and 70°, which allows the second body 2 to rotate from a coplanar state with the first body 1 to a state where it forms a second angle B of 110° with the first body 1. The rotational angle of the second connection apparatus 6 can be set between 0° and 180°, which allows the third body 3 to rotate from a position adjacent to the second body 2 to a coplanar state with the second body 2.

In the above embodiment, because the first force provided by the first connection apparatus 5 is set to be greater than the second force provided by the second connection apparatus 6, the second body 2 can remain stationary relative to the first body 1, when the third body 3 rotates relative to the second body 2. This facilitates switching the electronic device from the first device form to the second device form, or from the second device form back to the first device form.

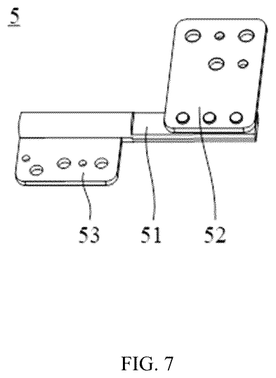

In some embodiments of the present disclosure, as illustrated in in FIG. 7, it shows a diagram of the structure of the first connection apparatus 5 in the electronic device provided by the present disclosure. The first connection apparatus 5 can be configured to include a first rotation shaft 51, a first connection member 52, and a second connection member 53. One of the first connection member 52 and the second connection member 53 is rotatably connected to the first rotation shaft 51, while the other of the first connection member 52 and the second connection member 53 is fixedly connected to the first rotation shaft 51. The first connection member 52 is fixedly connected to the first side 21 of the second body 2, and the second connection member 53 is fixedly connected to the first body 1, which enables the first side 21 of the second body 2 to be rotatably connected to the first body 1.

In the embodiments of the present disclosure, the first connection apparatus 5 needs to be connected to the first body 1 and the second body 2, respectively. The first connection member 52 can be configured in the first connection apparatus 5, and it can be configured to match the connection structure on the first side 21 of the second body 2, which allows the first connection member 52 to be fixedly connected to the second body 2. The second connection member 53 can also be configured in the first connection apparatus 5, and it can be configured to match the connection structure on the first body 1, which allows the second connection member 53 to be fixedly connected to the first body 1.

In an exemplary embodiment, the first connection member 52 can be rotatably connected to the first rotation shaft 51, while the second connection member 53 is fixedly connected to the first rotation shaft 51. Alternatively, the second connection member 53 can be rotatably connected to the first rotation shaft 51, while the first connection member 52 is fixedly connected to the first rotation shaft 51. In this case, the first connection member 52 can rotate relative to the second connection member 53 through the first rotation shaft 51, which allows the second body 2 to be rotatably connected to the first body 1. For instance, at least two first connection apparatus 5 can be arranged between the first body 1 and the second body 2, allowing the second body 2 to be rotatably connected to the first body 1.

In the above embodiment, since the first connection apparatus 5 includes both the first connection member 52 and the second connection member 53, the first connection apparatus 5 can be fixedly connected to the second body 2 and the first body 1, respectively. By configuring one of the first connection member 52 and the second connection member 53 rotatably connected to the first rotation shaft 51, and the other fixedly connected to the first rotation shaft 51, the first connection member 52 can rotate relative to the second connection member 53, which enables the second body 2 to rotate relative to the first body 1.

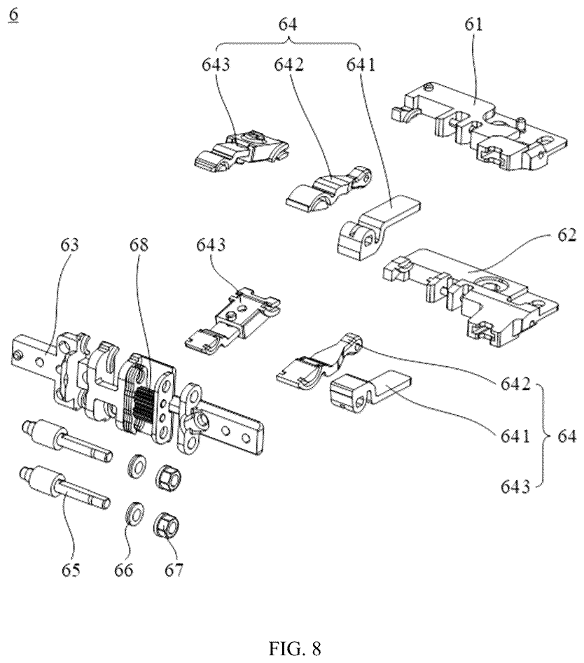

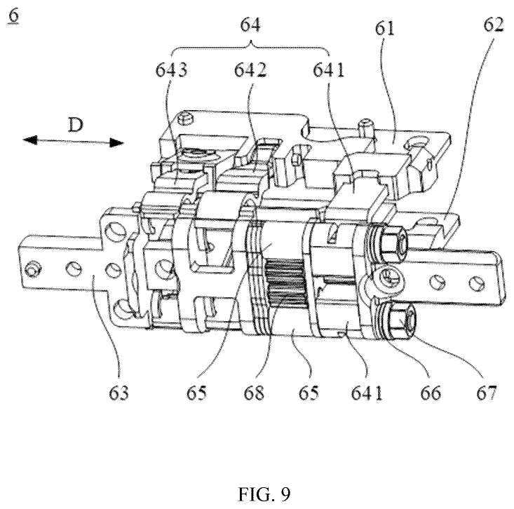

In some embodiments of the present disclosure, referring to FIG. 8 and FIG. 9, FIG. 8 shows an exploded view of the second connection apparatus 6 in the electronic device provided by the present disclosure, and FIG. 9 shows a diagram of the structure of the second connection apparatus 6 in the electronic device provided by the present disclosure. The second connection apparatus 6 can include a structure comprising a third connection member 61, a fourth connection member 62, and an intermediate connection member 63. The third connection member 61 and the fourth connection member 62 are both rotatably connected to the intermediate connection member 63 via a transmission assembly 64, which allows the third connection member 61 and the fourth connection member 62 to rotate relative to the intermediate connection member 63. The third connection member 61 is fixedly connected to the second side 22 of the second body 2, and the fourth connection member 62 is fixedly connected to the third body 3, which allows the third body 3 to be rotatably connected to the second side 22 of the second body 2.

In the embodiments of the present disclosure, as shown in FIG. 8, the second connection apparatus 6 is required to be connected to both the third body 3 and the second body 2. The third connection member 61 can be configured in the second connection apparatus 6 and configured to match the connection structure on the second side 22 of the second body 2, which allows the third connection member 61 to be fixedly connected to the second body 2. The fourth connection member 62 can be configured in the second connection apparatus 6 and configured to match the connection structure on the third body 3, allowing the fourth connection member 62 to be fixedly connected to the third body 3.

In an exemplary embodiment, the third connection member 61 can be rotatably connected to the intermediate connection member 63 via a transmission assembly 64, and the fourth connection member 62 can also be rotatably connected to the intermediate connection member 63 via the transmission assembly 64. In this case, both the third connection member 61 and the fourth connection member 62 can rotate relative to the intermediate connection member 63 through the transmission assembly 64, which allows the third body 3 to rotate relative to the second body 2.

In another exemplary embodiment, as shown in FIG. 8, the transmission assembly 64 can include a structure comprising a sliding member 641, a first rotating member 642, and a second rotating member 643. One end of the sliding member 641 can be slidably connected to either the third connection member 61 or the fourth connection member 62, while the other end of the sliding member 641 is rotatably and dampedly connected to the intermediate connection member 63. One end of the first rotating member 642 can be rotatably connected to either the third connection member 61 or the fourth connection member 62, and the other end of the first rotating member 642 can be rotatably and slidably connected to the intermediate connection member 63. Specifically, an arc-shaped sliding slot and guide rail can be configured on both the first rotating member 642 and the intermediate connection member 63. When the first rotating member 642 slides relative to the intermediate connection member 63 through the arc-shaped sliding slot and guide rail, it can also rotate relative to the intermediate connection member 63. One end of the second rotating member 643 can be rotatably and slidably connected to either the third connection member 61 or the fourth connection member 62. In this case, an arc-shaped sliding slot and guide rail can also be provided on the second rotating member 643, and the third connection member 61 or the fourth connection member 62. When the second rotating member 643 slides relative to the third connection member 61 or the fourth connection member 62 through the arc-shaped sliding slot and guide rail, it can also rotate relative to the third connection member 61 or the fourth connection member 62. The other end of the second rotating member 643 is also rotatably and slidably connected to the intermediate connection member 63, meaning that an arc-shaped sliding slot and guide rail are provided on both the second rotating member 643 and the intermediate connection member 63. When the second rotating member 643 slides relative to the intermediate connection member 63 through the arc-shaped sliding slot and guide rail, it can also rotate relative to the intermediate connection member 63.

In another exemplary embodiment, a second rotation shaft 65 can be configured in the second connection apparatus 6, to rotatably connect the sliding member 641 to the intermediate connection member 63 via the second rotation shaft 65. For example, the sliding member 641 can be fixedly connected to the second rotation shaft 65, and the second rotation shaft 65 can be rotatably connected to the intermediate connection member 63. Additionally, along the axial direction D of the second rotation shaft 65, an elastic member 66 can be configured between the second rotation shaft 65 and the intermediate connection member 63. For instance, a Belleville Spring or spring plate can be sleeved around the second rotation shaft 65. Moreover, a fastener 67, such as a nut, can be configured on the second rotation shaft 65 to adjust the compression of the elastic member 66. The axial damping force between the second rotation shaft 65 and the intermediate connection member 63 can be adjusted via the elastic member 66, which adjusts the rotational torque between the third connection member 61 and the intermediate connection member 63, as well as between the fourth connection member 62 and the intermediate connection member 63. This allows for adjusting the torque of the second connection apparatus 6, which ensures that the torque of the second connection apparatus 6 is smaller than that of the first connection apparatus 5.

In another exemplary embodiment, as shown in FIG. 8 and FIG. 9, a

synchronizing member 68 can be configured between the two second rotation shafts 65 of the second connection apparatus 6, which allows the two second rotation shafts 65 to rotate synchronously in opposite directions. For example, teeth can be configured on each of the two second rotation shafts 65, and the synchronizing member 68 can be configured as two gears that mesh with these teeth. The two gears engage with each other and respectively engage with the teeth on each of the second rotation shafts 65. In this case, when one of the second rotation shafts 65 rotates, the other second rotation shaft 65 will rotate synchronously in the opposite direction through the transmission of the two gears.

In another exemplary embodiment, as shown in FIG. 8 and FIG. 9, along the axial direction D of the second rotation shaft 65, a connecting structure, such as connecting holes, can be configured at both ends of the intermediate connection member 63. Connection members, such as linkages, can be used to connect at least two second connection apparatus 6 as a single unit, allowing the third body 3 and the second body 2 to be rotatably connected via at least two second connection apparatus 6.

In the above embodiment, since both the third connection member 61 and the fourth connection member 62 are rotatably connected to the intermediate connection member 63 through the transmission assembly 64, the second body 2, which is connected to the third connection member 61, and the third body 3, which is connected to the fourth connection member 62, are able to rotate relative to each other. The transmission assembly 64 is designed not only to rotate relative to the third connection member 61 and the fourth connection member 62, but also to slide relative to them while rotating. Furthermore, the transmission assembly 64 is configured to rotate relative to the intermediate connection member 63 while simultaneously sliding relative to the intermediate connection member 63. During the process in which the third body 3 rotates relative to the second body 2, the rotational axis of the third body 3 relative to the second body 2 can continuously change, which ensures that the rotational axis of the third body 3 relative to the second body 2 always coincides with the rotational axis of the first surface 41 of the display assembly 4. This reduces the risk of the display assembly 4 being damaged by external forces during rotation. Additionally, by rotatably connecting the sliding member 641 to the intermediate connection member 63 via the second rotation shaft 65 and placing an elastic member 66 between the second rotation shaft 65 and the intermediate connection member 63, the torque between the second rotation shaft 65 and the intermediate connection member 63 can be adjusted through the elastic member 66. This allows the torque between the third connection member 61 and the fourth connection member 62, and the intermediate connection member 63, to be individually adjusted. Consequently, the torque between the third body 3 and the second body 2 can also be adjusted, which ensures that the torque relationship between the second connection apparatus 6 and the first connection apparatus 5 satisfies the operational requirements of the electronic device.

In the above embodiment, since both the third connection member 61 and the fourth connection member 62 are rotatably connected to the intermediate connection member 63 through the transmission assembly 64, the second body 2, which is connected to the third connection member 61, and the third body 3, which is connected to the fourth connection member 62, can rotate relative to each other. The transmission assembly 64 is designed not only to rotate relative to the third connection member 61 and the fourth connection member 62, but also to slide relative to the third connection member 61 and the fourth connection member 62 while rotating. Furthermore, the transmission assembly 64 is configured to rotate relative to the intermediate connection member 63, and also to slide relative to the intermediate connection member 63. During the rotation process of the third body 3 relative to the second body 2, the rotational axis of the third body 3 can continuously change relative to the second body 2, which ensures that the rotational axis of the third body 3 always coincides with the rotational axis of the first surface 41 of the display assembly 4. This reduces the risk of the display assembly 4 being damaged by external forces during rotation. At the same time, the sliding member 641 is rotatably connected to the intermediate connection member 63 via the second rotation shaft 65, and the elastic member 66 is placed between the second rotation shaft 65 and the intermediate connection member 63. The elastic member 66 allows the adjustment of the torque between the second rotation shaft 65 and the intermediate connection member 63, which enables individual adjustments of the torque between the third connection member 61 and the fourth connection member 62 with the intermediate connection member 63. Consequently, the torque between the third body 3 and the second body 2 can also be adjusted, which enables that the torque relationship between the second connection apparatus 6 and the first connection apparatus 5 satisfies the operational requirements of the electronic device.

In some embodiments of the present disclosure, the first connection apparatus 5 has a first locking assembly, and the first locking assembly is used to limit the rotation angle of the second body 2 relative to the first body 1. Either additionally or optionally, the second connection apparatus 6 has a second locking assembly, and the second locking assembly is used to limit the rotation angle of the third body 3 relative to the second body 2.

In the embodiments of the present disclosure, the first locking assembly can be configured in the first connection apparatus 5, and the first locking assembly can be configured to limit the rotation angle of the first connection apparatus 5. For example, the first locking assembly can be set to stop the rotation of the first connection apparatus 5 after it has rotated a preset angle, when subjected to an external force. When further applying external force, the first connection apparatus 5 can continue rotating by another preset angle. In this case, during the rotation of the second body 2 relative to the first body 1, the first locking assembly can limit the rotation angle of the second body 2 relative to the first body 1. For instance, the first locking assembly can be configured as a ratchet, a dial, or some similar structure.

In some embodiments of the present disclosure, the second locking assembly can also be configured in the second connection apparatus 6, and the second locking assembly can be configured to limit the rotation angle of the second connection apparatus 6. For example, the second locking assembly can be set to stop the rotation of the second connection apparatus 6 after it has rotated a preset angle when subjected to an external force. When further applying external force, the second connection apparatus 6 can continue rotating by another preset angle. Alternatively, the second locking assembly is configured so that, after being subjected to an external force, the second connection apparatus 6 can only rotate in a preset direction. Moreover, the second connection apparatus 6 can rotate in the opposite direction, only when the rotation angle of the second connection apparatus 6 reaches the maximum angle. In this case, during the rotation process of the third body 3 relative to the second body 2, the second locking assembly can limit the rotation angle or direction of the third body 3 relative to the second body 2. For instance, the second locking assembly can be configured as a ratchet, a dial, or some similar structure.

In the above embodiment, since the first connection apparatus 5 is configured with the first locking assembly, and the second connection apparatus 6 is configured with the second locking assembly, the rotation angle of the second body 2 relative to the first body 1 can be restricted, and the rotation angle of the third body 3 relative to the second body 2 can be restricted as well. This ensures that when switching between different forms of the electronic device, the form of the device can be determined, which allows the electronic device to remain in a stable form.

In some embodiments of the present disclosure, the second body 2 of the electronic device includes a support assembly 7. One end of the support assembly 7 is movably connected to the surface of the second body 2 opposite the display assembly 4. In the second device form, the support assembly 7 is positioned at an angle relative to the second body 2, and the other end of the support assembly 7 abuts against a supporting surface, which provides support for both the second body 2 and the third body 3.

In the embodiments of the present disclosure, as shown in FIG. 4, FIG. 5, and FIG. 6, the support assembly 7 can be configured in the electronic device. The support assembly 7 is used to support the electronic device, when the electronic device is in the second device form.

In an exemplary embodiment, the support assembly 7 can be configured on the surface of the second body 2 opposite the display assembly 4. The support assembly 7 can be detachably connected to the second body 2, or it can be rotatably or slidably connected. In this case, when the electronic device is in the second device form, one end of the support assembly 7 can be connected at an angle to the surface of the second body 2 opposite the display assembly 4, and the other end of the support assembly 7 can be positioned away from the first body 1. This enables the support assembly 7 to provide support for both the second body 2 and the third body 3, which improves the stability of the electronic device, when placed in the second device form. Meanwhile, by movably connecting the support assembly 7 to the second body 2, it becomes easier to store the support assembly 7.

The above are merely preferred embodiments of the present disclosure and are not intended to limit the scope of the present patent. Any equivalent structural or procedural transformations made based on the contents of the description and the accompanying drawings, or direct or indirect applications in other related technical fields, are to be included within the scope of protection of the present patent. In particular, as long as there is no structural conflict, the technical features mentioned in the various embodiments can be combined in any manner. The present application is not limited to the specific embodiments disclosed in the document, and any equivalent structural transformations or direct or indirect applications in other related technical fields based on the content of the description and the accompanying drawings are likewise included within the scope of protection of the present patent.

What is claimed is:

1. An electronic device, comprising:
a first body including an input assembly, an input surface of the input assembly being used as a first functional surface of the first body;
a second body, a first side of the second body being rotatably connected to the first body;
a third body rotatably connected to a second side of the second body;
a display assembly including a first surface and a second surface arranged opposite the first surface, the first surface being a display output surface of the display assembly, and the second surface being connected to the second body and the third body, and the display output surface not overlapping with the input surface;
wherein:
in response to the third body rotating relative to the second body to form a first device form, then the display assembly is in a first deformed state, and in the first deformed state, the input surface and the display output surface of the display assembly are on a same side relative to the electronic device; and
in response to the third body rotating relative to the second body and the second body rotating relative to the first body, to form a second device form, the display assembly is in a flat state, and the input surface and the display output surface of the display assembly that is in the flat state are on a same side relative to the electronic device.

2. The electronic device according to claim 1, wherein the first body has a second functional surface, and the second functional surface is configured to abut against a supporting surface to support the third body connected to the second body.

3. The electronic device according to claim 1, wherein:
in the first device form, the first body and the second body satisfy a coplanar condition, and the second body and the third body form a first angle; and
in the second device form, the second body and the third body form the first angle or satisfy the coplanar condition, and the second body and the first body form a second angle.

4. The electronic device according to claim 1, wherein:
the electronic device has a closed form;
in the closed form, the first body and the second body satisfy the coplanar condition, and an orthogonal projection of the third body in a thickness direction at least partially covers the first body and the second body; and
the first functional surface is on a side of the display output surface of the display assembly and satisfies the coplanar condition with at least a part of the display output surface.

5. The electronic device according to claim 1, wherein:
a first side and a second side are two opposite sides of the second body;
the first side of the second body is connected to the first body via a first connection apparatus to form and maintain the first device form;
the second side of the second body is connected to the third body via a second connection apparatus to form and maintain the second device form.

6. The electronic device according to claim 5, wherein:
the first connection apparatus is configured to provide a first force when the second body rotates relative to the first body;
the second connection apparatus is configured to provide a second force when the third body rotates relative to the second body; and
the first force is greater than the second force to allow the first device form to be switched to the second device form.

7. The electronic device according to claim 6, wherein:
the first connection apparatus includes a first rotation shaft, a first connection member, and a second connection member;
one of the first connection member and the second connection member is rotatably connected to the first rotation shaft, and the other one is fixedly connected to the first rotation shaft;
the first connection member is fixedly connected to the first side of the second body, and the second connection member is fixedly connected to the first body to rotatably connect the first side of the second body to the first body.

8. The electronic device according to claim 6, wherein:
the second connection apparatus includes a third connection member, a fourth connection member, and an intermediate connection member;
the third connection member and the fourth connection member are connected to the intermediate connection member via a transmission assembly to allow the third connection member and the fourth connection member to rotate relative to the intermediate connection member; and
the third connection member is fixedly connected to the second side of the second body, and the fourth connection member is fixedly connected to the third body to rotatably connect the third body to the second side of the second body.

9. The electronic device according to claim 5, wherein:
the first connection apparatus includes a first locking assembly configured to limit a rotation angle of the second body relative to the first body; and/or
the second connection apparatus includes a second locking assembly configured to limit the rotation angle of the third body relative to the second body.

10. The electronic device according to claim 1, wherein:
the second body includes a support assembly;
one end of the support assembly is movably connected to the surface of the second body opposite the display assembly; and
in the second device form, the support assembly and the second body have an angle, and the other end of the support assembly abuts against a carrier surface to support the second body and the third body.
